(19) United States
(12) Patent Application Publication
(10) Pub. No.: US 2016/0305400 A1
(43) Pub. Date: Oct. 20, 2016

(54) MULTISEGMENT VERTICAL AXIS WIND TURBINE

(71) Applicants: Waldemar PISKORZ, Koden (PL); Tomasz PISKORZ, Koden (PL); Irenusz PISKORZ, Koden (PL)

(72) Inventors: Waldemar Piskorz, Koden (PL); Tomasz Piskorz, Koden (PL); Ireneusz Piskorz, Koden (PL)

(21) Appl. No.: 15/102,173

(22) PCT Filed: Dec. 8, 2014
(86) PCT No.: PCT/IB2014/066700

§ 371 Date: Jun. 6, 2016

(30) Foreign Application Priority Data
Dec. 6, 2013 (PL) P.406415

(51) Int. Cl. F03D 3/04; F03D 3/02; F03D 3/00

(52) U.S. Cl. CPC F03D 3/0409; F03D 3/005; F03D 3/02

(57) ABSTRACT

The subject of the invention is a multisegment wind turbine with horizontal rotation axis. The essential feature of the solution according to the invention is that it consists of separate rotors-segments (1), where at least one segment (1) of the turbine is equipped with at least one additional rim (9) or (9) and upper units (17) connected removably to guide vanes (7) of the segment (1) and to the rim (9) of the segment below or to solid supports (2) of the foundation, where the rim (9) consists of eight sheets (10) and eight lower and upper covers (10a) that make a closed structure.

The present invention is a multisegment wind turbine with vertical rotor rotation axis.

There are known guide vanes of multiple shapes, installed in the housing of turbine rotor, said guide vanes inclined at an angle providing optimal stream of air to be directed on rotor blades. Wind turbine power depends on the dimensions of the rotor, which requires larger size of the housing equipped with guide vanes, but large dimensions of housings are an impediment in transportation.

The essential feature of the invention is that in the wind tower, consisting of separate rotors-segments, at least one segment is equipped with additional attachments in a form of one or more rims, which are removably connected to the guide vanes and to solid supports of the foundation. The rims of located-higher elements are fixed to the rims placed directly below them. Preferably, the rim has eight sheets and eight upper and lower covers, which together form a closed structure. The sheets are placed on the same plane as the guide vanes and are connected to them with clamps, that are included in the inner vertical sheets edge. The outer, vertical edges of the sheets are equipped with stiffening ribs in the form of pipes. Preferably, the sheets are connected with those guide vanes, which are joined with carrier pipes of the segment. The upper ends of ribs of the neighboring sheets of one of the rims are joined removably together with stiff bars. The sheets are also connected with lower ends of the ribs with supports embedded in the foundation. The sheets of rims placed higher in respect to segments placed lower, are connected removably with lower ends of ribs to ribs of sheets of lower placed segments. Each of the lower and upper covers of the inner rim fills the area designated by horizontal edges of two neighbouring sheets, the bar that connects those sheets and a part of edge of the segment cover plate.

The inner rim sheets ribs are equipped with joints in a form of flat bar with holes, located in the same plane as the sheet.

The outer rim consists preferably of eight sheets and eight lower and upper covers that make a closed structure. The outer plates have, on their vertical edges, clamps to connect to joints of the inner sheets. Preferably, the sheets of the inner rim and the sheets of the outer rim are located in one plane. The outer sheets on the outer, vertical edge also have rims, the upper ends of which of the neighbouring outer sheets, for every segment separately, are connected together removably using stiff bars. The lower ends of ribs of the outer sheets are also connected removably with supports embedded in the foundation. The lower and upper covers of the outer rim cover the space designated by the neighbouring edges, the inner rim bar and the outer rim bar.

The solution according to the invention allows larger inlet of air to a segment rotor, which increases the power of the wind turbine.

Moreover, the housing of multisegment turbine with rims making a stiff construction also increases stiffness of the installation.

The subject of the invention is shown in the example of a drawing, where

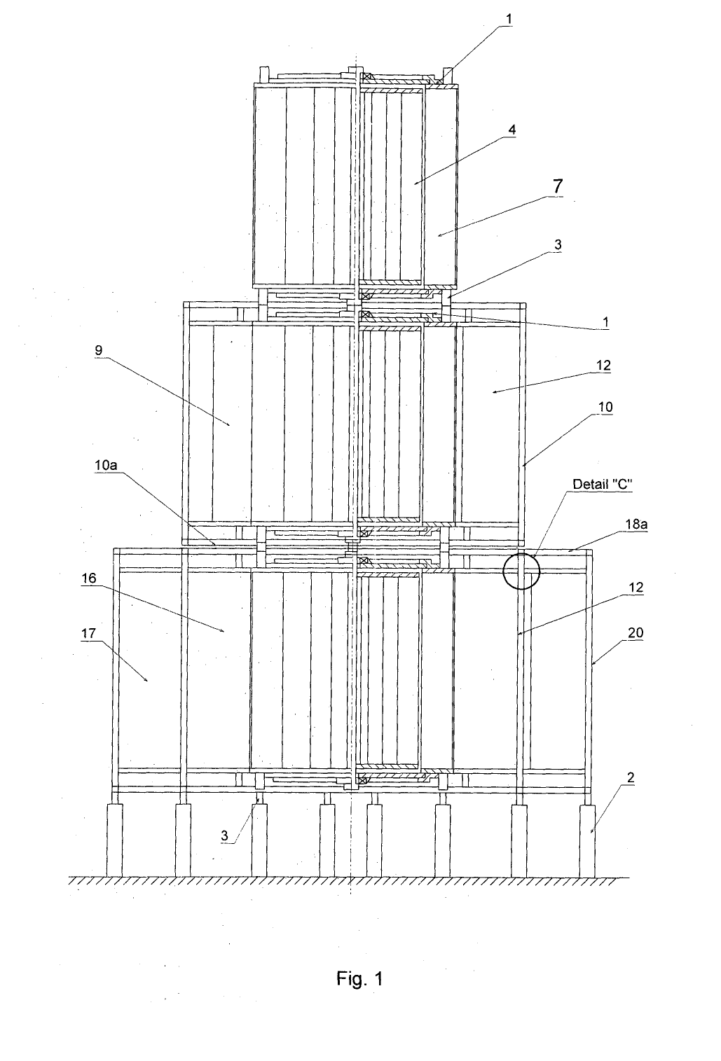

FIG. 1 shows a view with partial section of the wind turbine consisting of three segments, two of which are cased with rims of attachments;

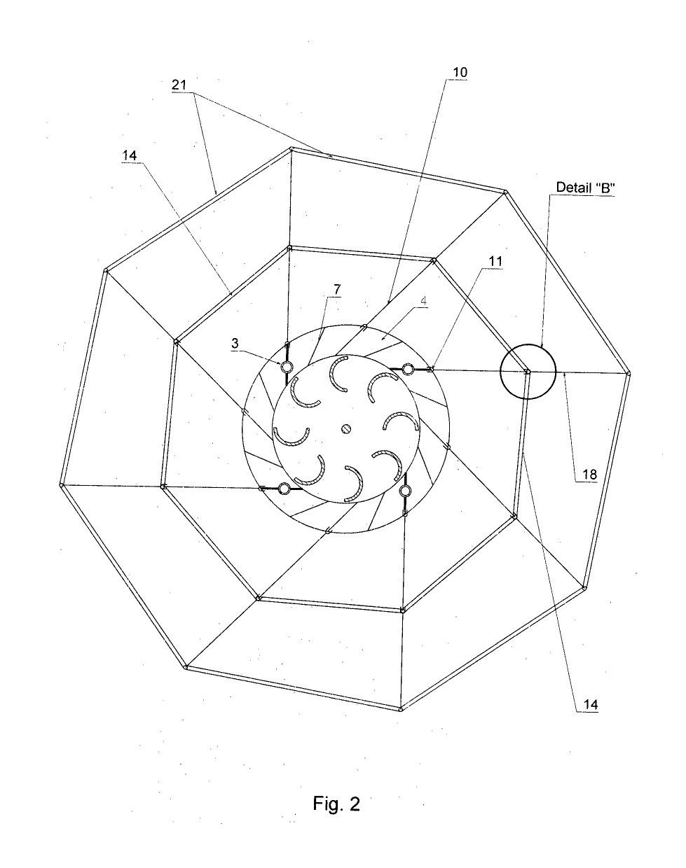

FIG. 2 shows a cross-section of the middle segment with one rim of attachments;

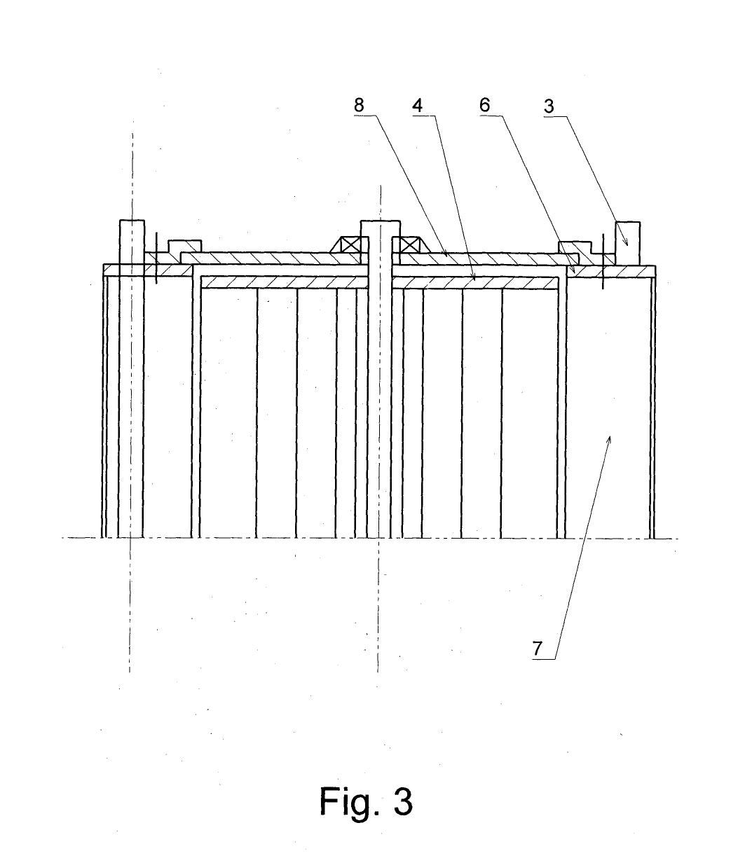

FIG. 3 shows partial section of a segment;

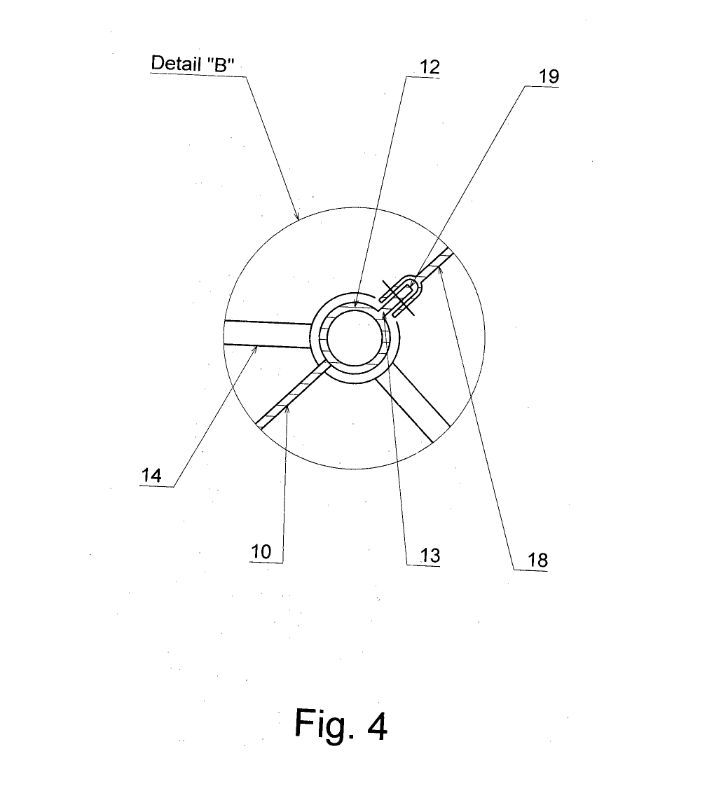

FIG. 4 shows a detail of joining of two sheets of the same segment;

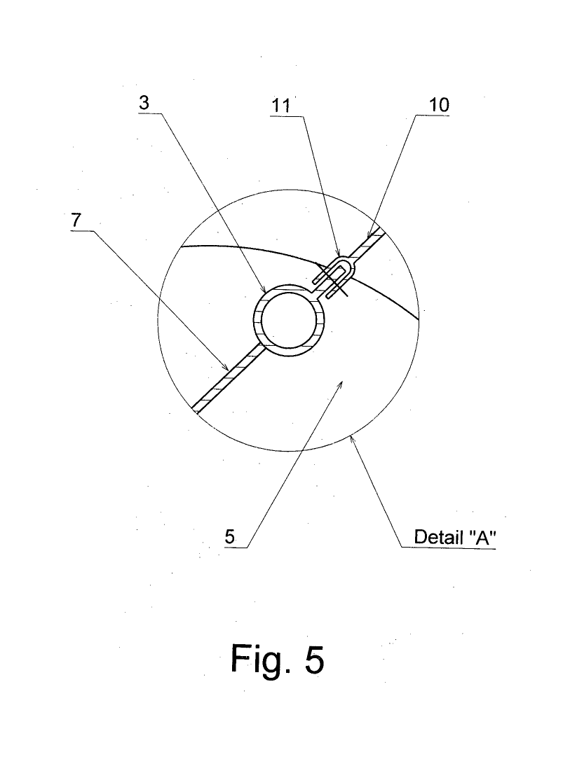

FIG. 5 shows the detail of joining of a sheet with guide vane of the segment, and

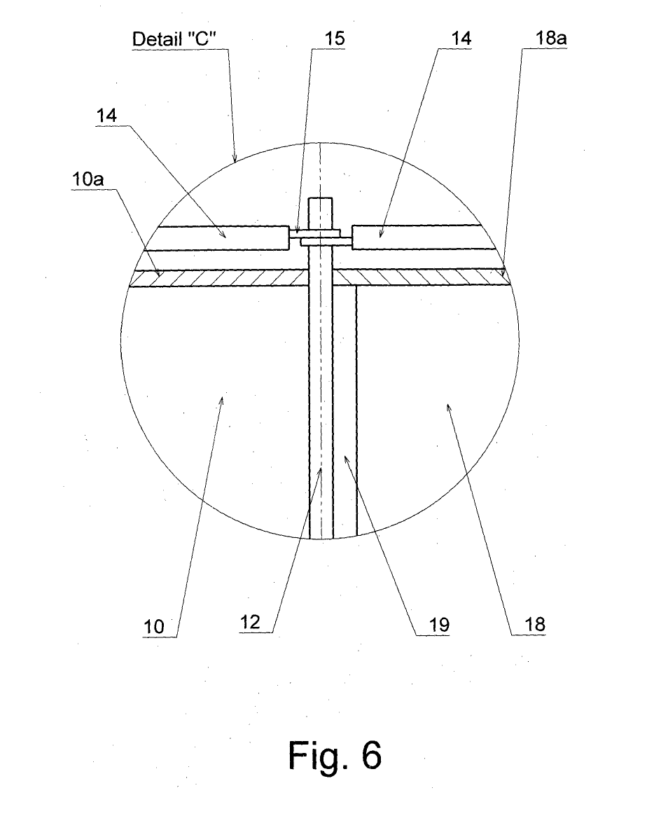

FIG. 6 shows the details of joining of ribs of the inner rim sheets.

The wind turbine combined of three rotor-segments 1 is embedded on supports 2 with four supporting pipes 3, the ends of which are connected together between the segments 1. The segment 1 has a rotor 4 embedded in bearings in a housing 5, consisting of two plates 6 connected with sixteen guide vanes 7 and pipes 3. The upper plate 6 is rim shaped and has circular cover 8 with bearings connected removably. Eight guide vanes 7 have larger cross sectional dimension, and four of them are combined with supporting pipes 3.

The middle segment 1 is equipped with a rim 9 of attachments created by eight sheets 10 in a form of a metal sheet and eight lower and upper covers 10a. One of the vertical edges—the inner one—of the sheet has a clamp 11, while the second vertical outer edge is reinforced with rib 12 in a form of a pipe, the ends of which protrude beyond vertical edges of sheet 10. Moreover, the ribs 12 have connectors 13 in a form of a flat bar with holes for connection, and each of the connectors 13 is situated in the plane of sheet 10. In the clamp 11 of the sheet 10 a fragment of guide vane 7 is introduced, with which it is connected with screws and sheet 10 is situated in plane of the guide vane 7 that is connected to it. The sheets are connected to those guide vanes 7 that have larger cross-section and four of them are joined with pipes 3. The upper ends of ribs 12 of the neighbouring sheets are connected with a bar 14 with lugs 15. The lower ends of neighbouring sheets ribs 12 are connected with upper ends of ribs 12 of the lower segment 1. The lower and upper covers 10a cover space designated by the edges of neighboring sheets 10, the bar 14 and a part of plate 6. The lower and upper covers 10a are connected with sheets 10 and plate 6 making a closed structure in the form of four planes of truncated pyramid.

The lower segment 1 is equipped with two rims 16 and 17 of attachments, where the rim 16 has the same structure as the rim 9, except that the lower ends of ribs 12 are fixed to supports 2. The outer rim 17 has eight sheets 18 and eight lower and upper covers 18a. Each of the sheets 18 is equipped with a clamp 19 and a rib 20. The sheets 18 are connected with sheets 10 via connectors 13 and clamps 19 connected with coupling means. Moreover, the neighbouring sheets 18 are connected with bars 21. The sheets 18 are located in one plane with the connecting sheets 10. Lower ends of the ribs 20 are connected removably with supports 2. The lower and upper covers 18a cover the space designated by edges of the neighboring plates 18, the bar 21 and the bar 14. The lower and upper covers 18a are connected to sheets 18 and the cover 10a, making a closed structure in the form of four planes of truncated pyramid.

1. A multisegment wind turbine with vertical rotation axis of a rotor embedded in a bearings, in a housing consisting of plates, between which air guide vanes and pipes that make supporting structure are fixed, characterised in that it consists of separate rotor-segments, where at least one segment of the turbine is equipped with at least one additional attachment in a form of a rim, or and attachments fixed removably to guide vanes of segment, and to rim of the segment located below or solid supports of the foundation.

2. The multisegment wind turbine according to claim 1, characterized in that the rim is composed of eight sheets and eight lower and upper covers, where the sheets are preferably located in one plane with the guide vanes, moreover the sheets and the covers make a closed structure.

3. The multisegment wind turbine according to claim 1, characterized in that the sheets are connected with the guide vanes with clamps, the inner vertical edge of the sheet is equipped with, wherein the outer, vertical edges of the sheets are equipped with stiffening rims in the form of pipes, whose upper ends of ribs of the neighbouring sheets are mutually connected with the stiff bars, moreover the sheets are connected with supports with lower ends of the ribs.

4. The multisegment wind turbine according to claim 1, characterized in that each of the covers covers an area designated by horizontal edges of the two neighboring sheets, a bar that connects those sheets and a fragment of rim of the plate.

5. The multisegment wind turbine according to claim 1, characterized in that the sheets are fixed with ends of ribs to the sheets of segments below.

6. The multisegment wind turbine according to claim 1, characterized in that the guide vanes that are fixed to support pipe of the segment are connected to sheets.

7. The multisegment wind turbine according to claim 2, characterized in that ribs of the sheets are equipped with connectors in the form of a flat bar with holes.

8. The multisegment wind turbine according to claim 1, characterized in that the outer rim consists of eight sheets and eight lower and upper covers, where the sheets of the rim are preferably placed in one plane with the sheets, with which they are connected, where the neighbouring sheets of the rim and the covers form a closed structure.

9. The multisegment wind turbine according to claim 1, characterized in that the lower and upper covers cover space designated by edges of neighbouring sheets, the bar of outer rim and the bar of inner rim.

10. The multisegment wind turbine according to claim 1, characterized in that the outer sheets have ribs on the outer, horizontal edge, whose upper ends of the neighbouring outer sheets, separate for each segment are mutually connected removably with stiff bars, and the lower ends of ribs of outer sheets are also connected removably with supports embedded permanently in the foundation.

11. The multisegment wind turbine according to claim 1, characterized in that the outer sheet is connected to a sheet with a clamp and a connector.

12. The multisegment wind turbine according to claim 2, characterized in that the sheets are connected with the guide vanes with clamps, the inner vertical edge of the sheet is equipped with, wherein the outer, vertical edges of the sheets are equipped with stiffening rims in the form of pipes, whose upper ends of ribs of the neighbouring sheets are mutually connected with the stiff bars, moreover the sheets are connected with supports with lower ends of the ribs.

13. The multisegment wind turbine according to claim 2, characterized in that each of the covers covers an area designated by horizontal edges of the two neighboring sheets, a bar that connects those sheets and a fragment of rim of the plate.

14. The multisegment wind turbine according to claim 3, characterized in that each of the covers covers an area designated by horizontal edges of the two neighboring sheets, a bar that connects those sheets and a fragment of rim of the plate.

15. The multisegment wind turbine according to claim 3, characterized in that the sheets are fixed with ends of ribs to the sheets of segments below.

16. The multisegment wind turbine according to claim 2, characterized in that the outer rim consists of eight sheets and eight lower and upper covers, where the sheets of the rim are preferably placed in one plane with the sheets, with which they are connected, where the neighbouring sheets of the rim and the covers form a closed structure.

17. The multisegment wind turbine according to claim 2, characterized in that the lower and upper covers cover space designated by edges of neighbouring sheets, the bar of outer rim and the bar of inner rim.

18. The multisegment wind turbine according to claim 7, characterized in that the lower and upper covers cover space designated by edges of neighbouring sheets, the bar of outer rim and the bar of inner rim.

19. The multisegment wind turbine according to claim 2, characterized in that the outer sheets have rib on the outer, horizontal edge, whose upper ends of the neighbouring outer sheets, separate for each segment are mutually connected removably with stiff bars, and the lower ends of ribs of outer sheets are also connected removably with support embedded permanently in the foundation.

20. The multisegment wind turbine according to claim 7, characterized in that the outer sheets have ribs on the outer, horizontal edge, whose upper ends of the neighbouring outer sheets, separate for each segment are mutually connected removably with stiff bars, and the lower ends of ribs of outer sheets are also connected removably with supports embedded permanently in the foundation.
